(19) United States
(12) Patent Application Publication
(10) Pub. No.: US 2015/0317572 A1
(43) Pub. Date: Nov. 5, 2015

(54) On-Demand Enrichment of Business Data

(71) Applicant: Makesh Balasubramanian, Bangalore (IN)

(72) Inventor: Makesh Balasubramanian, Bangalore (IN)

(73) Assignee: SAP AG, Walldorf (DE)

(21) Appl. No.: 14/269,848

(22) Filed: May 5, 2014

(51) Int. Cl. G06Q 10/06

(52) U.S. Cl. CPC G06Q 10/063

(57) ABSTRACT

Techniques for systems, methods, and devices for providing on-demand enrichment data are disclosed. In response to user input, a client computing device executing a client application and plug-in for communicating with a data enrichment service, can generate a data enrichment command. The command can include selected report data from one or more reports or summaries displayed to a user on the client computing device. The command can also include information about the context in which data enrichment was requested. Using the information included in the command, an enrichment data service can determine the type of enrichment data that may be useful and the sources from which to request the enrichment data. The enrichment data can then be retrieved from one or more enrichment data sources and sent to the requesting client computing device to be displayed to the user in a manner that enriches the original reporting data.

### BACKGROUND

The present disclosure relates to computing systems, and in particular, to on-demand enrichment of data maintained and generated by business computing systems.

Unless otherwise indicated herein, the approaches described in this section are not admitted to be prior art by inclusion in this section.

In the course of conducting business, modern businesses can generate large quantities of data. Such data is often referred to as “business data” and can include many different types of transactional data (e.g., database inserts, deletes, updates, etc.) and analytical data (e.g., aggregated transactional data, filtered transactional data, etc.) regarding various aspects of the relevant business. To effectively manage and utilize such data, many businesses rely on various general-use and customized applications and computing systems, often referred to collectively as “business computing systems” or, more simply, as “business systems.” Typical business systems include database and analytical functionality for organizing and processing the data into accessible and meaningful information that various segments of the business (e.g., management teams, sales teams, manufacturing groups, etc.) can use to make decisions or improve the operations of the business.

Because the quantity of data handled by a particular business system can be considerable, many business systems include reporting capabilities that analyze and summarize business data in concise and easily consumable reports (e.g., tables of summarized sales data, expenses, costs, etc.) and visualizations (e.g., charts, graphs, icons, etc.) designed with specific use cases in mind For instance, information that a particular sales person might want to know about a customer may be different from the information that the accounting department may need to establish and service that particular customer. The sales person may want to know the names of the buyers and the customer's forecasted need for the business' product/services, while the accounting department may need to quickly evaluate the status of the customer's account with respect to delays in payment, outstanding balances, and most recent credit scores. In general, the type of information included in a particular report or visual representation can depend on the context in which the information is being requested and used. The context can include information about the requesting user, the user's preferences, that user's role in the business, the originating system of the request (e.g., the accounting system, the customer relations management system (CRM), enterprise resource planning systems (ERP), etc.), the time and date of the request, explicit preferences, and the like.

### SUMMARY

Embodiments of the present disclosure improve business data reporting tools with on-demand data enrichment. In one embodiment, the present disclosure includes a computer implemented method that includes generating, in response to a query received from a client computing device, reporting data including data from one or more records retrieved from one or more data sources, sending the reporting data from the computing system to the client computing system, and receiving a data enrichment command including a subset of the reporting data and a context in which the subset of the reporting data was determined The method further includes analyzing the subset of the reporting data and the context to determine an enrichment data source, determining a query syntax associated with the enrichment data source, generating a request for enrichment data based on the subset of the reporting data, the context, and the query syntax, and sending the request for enrichment data to the enrichment data source. The method may also include receiving enrichment data from the enrichment data source and sending the enrichment data to the client computing device.

In one embodiment, the one or more data sources can include a business module comprising analytical or transactional functionality.

In one embodiment, analyzing the context comprises accessing an enrichment data definition associated with the context, and wherein the data definition comprises a designation of an enrichment data type and the enrichment data source.

In one embodiment, the method also includes updating the enrichment data definition in response to feedback information received from the client computing device.

In one embodiment, determining the query syntax comprises accessing an enrichment data definition, associated with the context, and comprising a query template associated with the enrichment data source, and wherein generating the request comprises using the query template.

In one embodiment, the enrichment data source comprises an auxiliary data source external to the computer system.

In one embodiment, the method also includes processing the enrichment data to generate processed enrichment data comprising specifications for displaying the enrichment data, and wherein sending the enrichment data to the client computing device comprises sending the processed enrichment data.

Another embodiment of the present disclosure is directed to a non-transitory computer readable medium comprising instructions, that when executed by a computer processor, cause the computer processer to be configured for receiving, from a client computing device, a data enrichment command comprising reporting data comprising data from one or more records retrieved from one or more data sources, and a context in which the reporting data was selected. The instructions can further cause the computer processor to be configured for analyzing the reporting data and the context to determine an enrichment data source, determining a query syntax associated with the enrichment data source, and generating a request for enrichment data based on the reporting data, the context, and the query syntax. Additionally, the instructions can also cause the computer processor to be configured for sending the request for enrichment data to the enrichment data source, receiving, in response to the request for enrichment data, enrichment data from the enrichment data source, and sending the enrichment data to the client computing device.

Yet another embodiment of the present disclosure is directed to a system comprising a processor, and a memory coupled to the processor. The memory includes instructions that, when executed by the processor, cause the processor to be configured to receive, from a client computing device, a data enrichment command comprising reporting data comprising data from one or more records retrieved from one or more data sources, and a context in which the reporting data was determined, analyze the reporting data and the context to determine an enrichment data source, determine a query syntax associated with the enrichment data source, generate a request for enrichment data based on the reporting data, the context, and the query syntax, send the request for enrichment data to the enrichment data source, receive enrichment data from the enrichment data source, and send the enrichment data to the client computing device.

The following detailed description and accompanying drawings provide a better understanding of the nature and advantages of the present disclosure.

### BRIEF DESCRIPTION OF THE DRAWINGS

FIG. 1A is high level schematic of a data enrichment system according to an embodiment of the present disclosure.

FIG. 1B illustrates a data flow for data enrichment according to an embodiment of the present disclosure.

FIG. 2A illustrates an example data enrichment system according to a specific embodiment of the present disclosure.

FIG. 2B illustrates a data flow for data enrichment according to an embodiment of the present disclosure.

FIG. 3 is flowchart of a method for generating enrichment data according to an embodiment of the present disclosure.

FIGS. 4A to 4C illustrates an example user interface with data enrichment functionality according to an embodiment of the present disclosure.

FIG. 5 illustrates an example computer system and network in which various embodiments of the present disclosure can be implemented.

### DETAILED DESCRIPTION

Described herein are techniques for on-demand enrichment of business data. In the following description, for purposes of explanation, numerous examples and specific details are set forth in order to provide a thorough understanding of the present disclosure. It will be evident, however, to one skilled in the art that the present invention as defined by the claims may include some or all of the features in these examples alone or in combination with other features described below, and may further include modifications and equivalents of the features and concepts described herein.

Embodiments of the present invention provide for systems, methods, and techniques for on-demand enrichment of summary and report data compiled from raw data managed by one or more data sources (e.g., business modules). For example, reports generated from transactional and analytical data retrieved from one or more business modules (e.g., a CRM, ERP, etc.) in a business system can be supplemented with information retrieved from auxiliary data sources (e.g., specialized websites, industry reports, rating systems, etc.).

Embodiments can be implemented in client-server type configurations in which users access the functionality and business data in a business system, and its component business modules, using a client application executed on a client computing device. In such embodiments, the client application, a corresponding business module, or the business system itself can generate user interface elements (e.g., GUI buttons, selection tools, text fields, etc.) that augment the controls of a business data reporting or summary user interface. The user interface elements can then be used to select information from a report (e.g., data from a tabular summary, a numerical metric, etc.) or an analytical graphic (e.g., a data point from a bar chart or line graph) and activate the enrichment functionality directly from the business data reporting interface. The resulting enrichment data can then be generated based on the selected information. In some embodiments, the enrichment data may also be generated based on the context (e.g., the source business module or report type from which report information is selected, a name or identifier of the requesting user, user job function, etc.) in which the reporting data was selected. The resulting enrichment data can be displayed in one or more formats according to dynamically determined or predetermined specifications.

In some embodiments, the enrichment data can be provided by an enrichment service in the business system. The enrichment service can be a separate module or can be included in one or more other business modules executed in the business system. Accordingly, the data enrichment service can include functionality and logic for receiving data enrichment commands from the client device, determining the type and sources for the enrichment data, retrieving the enrichment data from the various sources, and then formatting and sending the enrichment data back to the client device. In embodiments, the enrichment service can store the resulting enrichment data along with the details of the data enrichment command to create a correlated history. The correlated history may include feedback from the client device about which enrichment data the user used or found most helpful. The history can then be used by the enrichment service to inform analysis of and/or be used as enrichment data in response to subsequent data enrichment commands. To illustrate these and other details of the present disclosure, functionality, configurations, and variations are described in reference to the following example embodiments and figures.

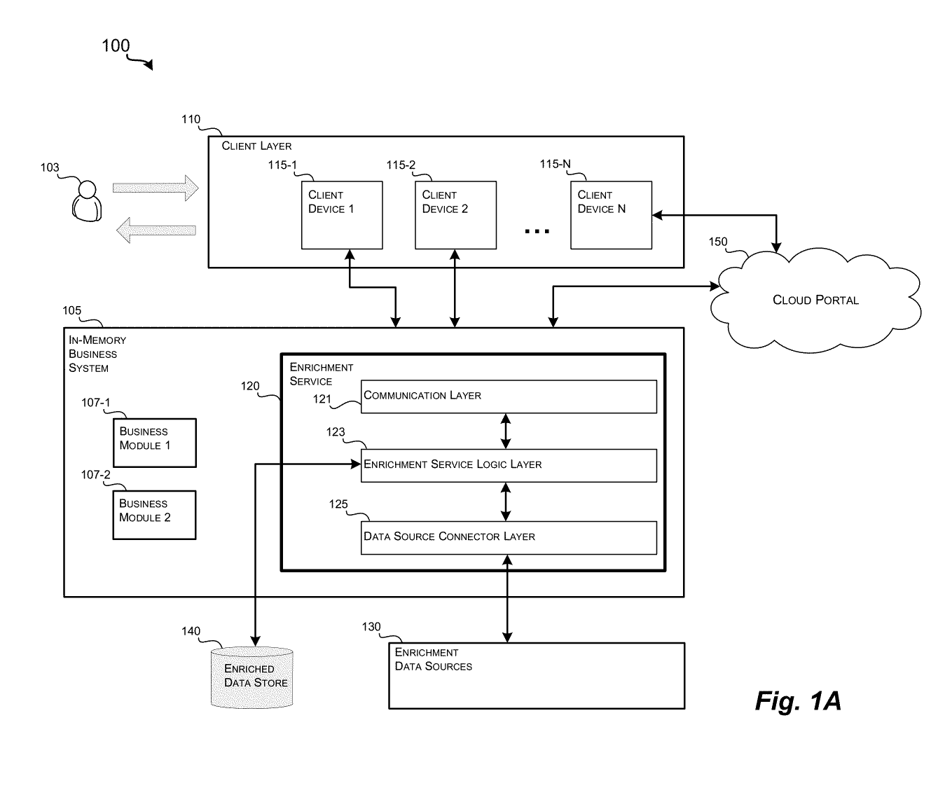

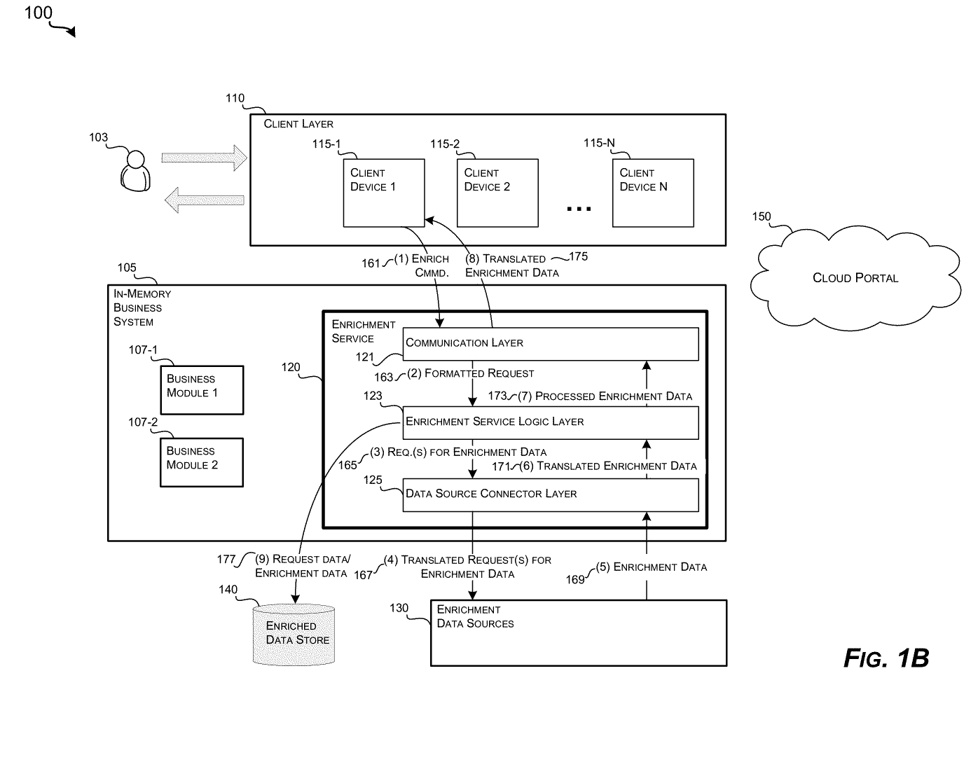

FIG. 1A is a high-level schematic diagram of a system 100 for providing on-demand enrichment data, according to one embodiment of the present disclosure. As illustrated, system 100 can include a business computing system for collecting, managing, analyzing, and reporting business data. In one embodiment, the business system can be implemented as an in-memory business system 105 with additional functionality provided by one or more business modules 107. Each business module 107 can be implemented as a combination of hardware and software. For example, a business module 107 can include an application executed on the same computer system on which the in-memory business system 105 is executed. Alternatively, a business model 107 can include an application executed on one or more computers (i.e., a cloud computing environment) in electronic communication with the computer system in which the in-memory business system 105 is executed.

The use of in-memory business system 105 can achieve various advantages based on the efficiency and speed with which it and business modules 107 can operate on data stored in a main-memory component (i.e. RAM) of the system. For example, a business module 107 that includes database storage and management functionality can execute queries and other operations on a database stored in a main memory component much faster than on a database stored in a traditional hard drive-based memory because of the elimination of time-consuming seek-read hard drive operations. However, while various illustrative examples are described in reference to the in-memory business system 105, one of ordinary skill in the art will recognize that various other types of business systems can be used to implement and be improved by embodiments of the present disclosure.

The in-memory business system 105 can be implemented in one or more server computers or in a cloud computing environment. In-memory business system 105 can include a number of component business modules 107, or applications, for performing various transactional and analytical functions. While not shown, such business modules 107 can be executed in and operate on data resident in the main memory component of the in-memory business system 105. In one embodiment, the in-memory business system 105 or the business modules 107 can include an enrichment service 120 for providing enrichment data to raw or processed data. For example, the enrichment service 120 can enrich the reporting data provided to one or more of the client devices 115 in the client layer 110.

Client devices 115 in the client layer 110 can include any type of computing device executing a corresponding proprietary or standardized client application (e.g., a web browser). The client devices 115 can communicate with the in-memory business system 120 through one or more electronic communication connections including open source or proprietary electronic communication media and protocols. Accordingly, the functionality of the business modules 107 can be accessed by one or more client devices 115 through the electronic communication connections.

The functionality of the various business modules 107, such as accounting functionality, customer relationship management (CRM) functionality, enterprise resource planning (ERP) functionality, data mining, business performance management (BPM) functionality, and the like, can be accessed by client devices 115. Client devices 115, executing client applications, can communicate with the in-memory business system 105 either directly through a local network connection or indirectly through a mobile network (not shown) or through a cloud portal 150 using a wide area network (e.g., the Internet).

For example, a user 103 can launch a particular client application on a client device 115 to initiate communication with one or more corresponding business modules 107 in the in-memory business system 105. In such embodiments, the client device 115 can generate a user interface, such as a graphical user interface (GUI), that the user 103 can use to interact with and control the target business modules 107. In response to user or other input received from a client device 115, one or more of the business modules 107 can retrieve and analyze data from one or more data stores accessible to the in-memory business system 105. The business model 107 can then send the data back to the requesting client device 115. The client device 115 can then use the received data to generate and display corresponding information from the data. In many implementations, the client device 115 can display the information from the data in a summary form. For example, information may be displayed as reporting data in the form of summary reports (e.g. a table summary or aggregated data) or as visual representations of summary reports (e.g., a graph or chart). As used herein, the term “reporting data” is used to refer to information provided to a user in a GUI rendered on a client device 115 that includes or is derived from data provided by one or more business modules 107.

In one embodiment, the in-memory business system 105 can also include an enrichment service module 120 that can include functionality for providing enrichment data for any data generated by one or more of the business modules 107 or client devices 115. As used herein, the term “enrichment data” refers to any data that is additional to or supplementary to the data retrieved, generated, or otherwise provided by the functionality of a business module 107 or a client device 115. Accordingly, in one embodiment, enrichment data may include any data or information provided to a user in addition to the information in a particular set of reporting data.

In embodiments, the enrichment service 120 can retrieve or generate enrichment data from one or more enrichment data sources 130, that are internal or external to the business system 105. For example, one of the business modules 107 can include address book functionality for maintaining contact information for key personnel in a business's customer list. When a client device 115 accesses the address book functionality of the particular business module 107, embodiments of the present disclosure can include controls in the user interface for requesting enrichment data for one or more of the names in the address book. For instance, the user 103 can select a particular name in the address book (e.g., click on or highlight the name) and then select an “enrich data” button. The client device 115 can then generate a data enrichment command. In some embodiments, the data enrichment command can include a request for enrichment data that can be added to reporting data being displayed on the client device 115. For example, the request for enrichment data can include a request for additional information that can be added to information displayed from one or more pieces of reporting data. The data enrichment command can then be sent to the enrichment service 120.

As shown, the enrichment service 120 can include a communication layer 121 to communicate with the various client devices 115. In some embodiments, the communication layer 121 can include functionality for communicating with a client application, or a plug-in module, using various secured and unsecured electronic communications techniques. In some embodiments, the communication layer 125 can also translate data enrichment commands received from the client devices 115 into a format usable by the enrichment service logic layer 123.

Enrichment service logic layer 123 can include functionality for analyzing information in the data enrichment commands. For example, such functionality can include parsing information from the data enrichment commands. Such information can include, but is not limited to, identification of the requesting user 103, identification of the requesting client device 115, the data selected from the reporting data, the source of the reporting data (e.g., the particular business module 107), a time/date, and other contextual information included in the data enrichment command. For example, enrichment service logic layer 123 can analyze a data enrichment command to determine that it included a customer name and was received through a user interface generated by a particular client device 115 for accessing an accounting specific business model 107. In this particular example, the context of the data enrichment command may imply that the user is interested in an accounting perspective on the selected customer. Accordingly, the enrichment service logic layer 123 can determine that it may be beneficial to query an external enrichment data source 130, such as a credit rating agency (e.g., Equifax™), to request a current credit report for that particular customer. The enrichment service logic layer 123 can then generate enrichment data requests for the corresponding target data enrichment data source. Because the structure of the query required by the external enrichment data source 130 may be different than the native format of the enrichment data request generated by the enrichment service logic layer 123, the enrichment service 120 can also include a data source connector layer 125 for translating communication between the enrichment service 120 and one or more different types of enrichment data sources 130.

In response to queries from the enrichment service 120, enrichment data sources 130 may send the requested enrichment data. Enrichment service 120 can then translate and process the enrichment data according to the needs of the requesting client device 115 and send the resulting enrichment data to the requesting client device 115 to be displayed to user.

In some embodiments, the enrichment service 120 can store the resulting enrichment data along with information from the data enrichment command in an enriched data store 140. The information stored in the enriched data store 140 can provide for historization of the requested enrichment data. The historization of enrichment data can be used by the enrichment service 120 to inform the analysis of the received data enrichment commands as well as to monitor various aspects of the reporting data and/or the enrichment data. For example, the data stored in the enriched data store 140 can be used to improve the analysis performed by the enrichment data service logic layer 123 to generate enrichment that is better suited to the needs of the users. In another example, the historization of the reporting data and/or the enrichment data can be analyzed to evaluate trends and possibly to generate forecasts for the data.

To further illustrate the functionality of the various components of the system 100, FIG. 1B depicts an example data flow of a particular interaction between the client layer 110, the in-memory business system 105, and one or more enrichment data sources 130. The particular example data flow illustrated in FIG. 1B includes communication between a client device 115-1 connected to the in-memory business system 105 over a local area network (LAN). In such embodiments, in which the client device 115-1 and the in-memory business system 105 are on the same LAN, various communication and security protocols can be implemented to secure the data provided by the business modules 107.

As shown, at action (1) (reference 161), client device 115-1 can send a data enrichment command to the enrichment service 120. The data enrichment command can include information selected from reporting data displayed on the client device 115 and other contextual information about the selected information and/or the reporting data. The communication layer 121 of the enrichment service 120 can receive the data enrichment command.

At action (2) (reference 163), the communication layer 121 can generate a formatted data enrichment request usable by the enrichment service logic layer 123. The enrichment service logic layer 123 can analyze the formatted request to determine one or more types of enrichment data that might be useful to the requesting user 103. Analyzing the formatted requests can include analyzing the selected information from the reporting data and/or the contextual data regarding the selected information and/or the reporting data. Based on the types of enrichment data that the enrichment service logic layer 123 determines might be useful, the enrichment service logic layer 123 can generate one or more requests for enrichment data, at action (3) (reference 165). The requests for enrichment data can include a designation of a target enrichment data source 130 and an indication of the requested data.

The data source connector layer 125 can determine the target enrichment data sources 130 based on the designation and generate corresponding translated request for enrichment data specific to the target enrichment data sources 130, at action (4) (reference 167). The translated request for enrichment data can then be sent to the target enrichment data sources 130. In response to the requests, at action (5) (reference 169), the corresponding enrichment data sources 130 can generate the requested enrichment data and send it back to the enrichment service 120.

The data source connector layer 125 can analyze the requested enrichment data and translate it into a format usable by the enrichment service logic layer 123. At action (6) (reference 171), the data source connector layer 125 can send translated enrichment data to the enrichment service logic layer 123. Enrichment service logic layer 123, at action (7) (reference 173), can process the translated enrichment data to generate processed enrichment data that is usable by the requesting client device 115-1.

At action (8) (reference 175), the communication layer can translate and send the processed enrichment data in a format usable by the client device 115-1. At that point the client device 115-1 can display the enrichment data to the requesting user 103. In some embodiments, enrichment data can be superimposed over or added to existing GUIs rendered on the client device 115-1. In such embodiments, the data flow depicted in FIG. 1B can be performed on demand in response to the user input received through the requesting client device 115-1. Accordingly, all of the actions described above can be performed in real time or near real time. It is in such embodiment that the capabilities of the in-memory business system 105 are advantageously realized for quickly accessing reporting data provided by the business modules 107, and processing the enrichment data command to quickly and efficiently provide enrichment data to the requesting client device 115.

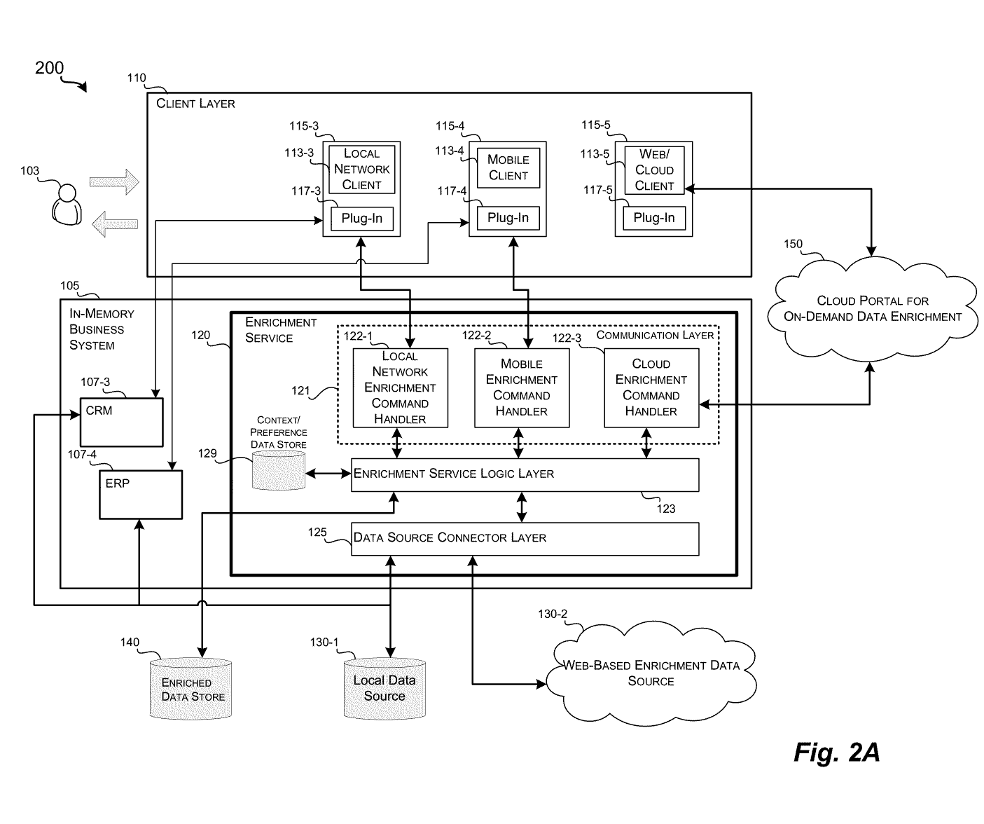

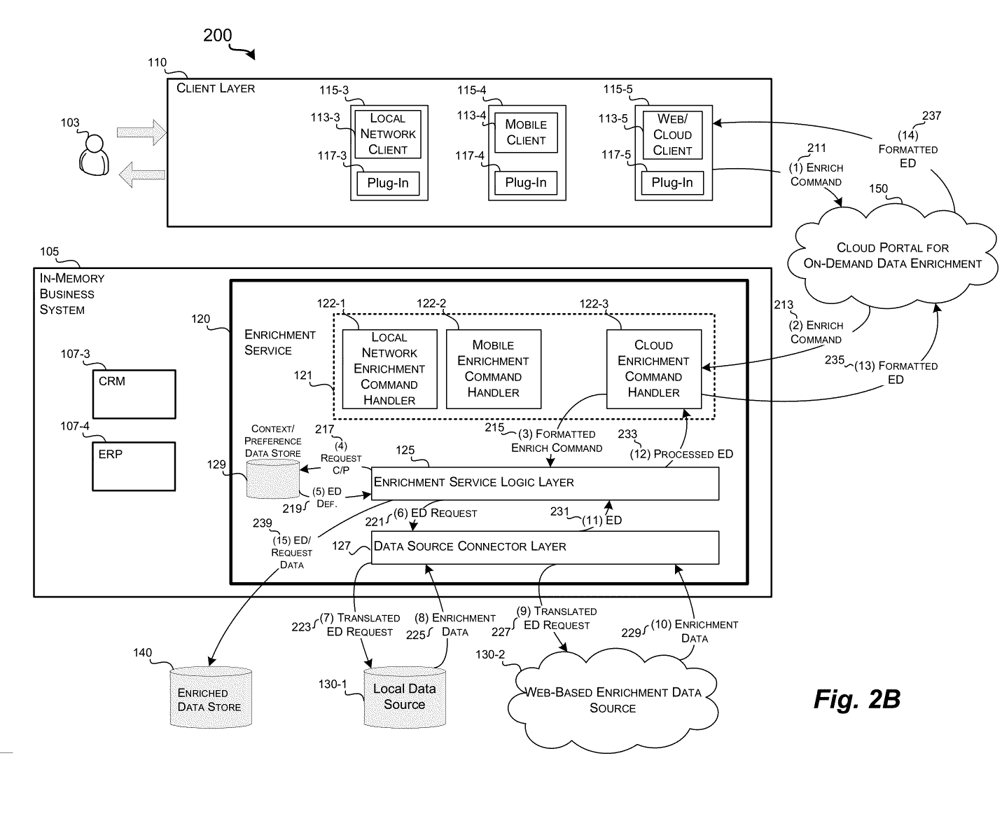

To further illustrate various details of the present disclosure, FIG. 2A depicts an example system 200 for providing enrichment data. System 200 illustrates client devices 115 that can execute one or more particular client applications 113 for communicating with corresponding business modules 107. For example, client device 115-3 can be a computing device, such as a desktop computer, laptop computer, tablet computer, or the like, executing a local network client application 113-3 specifically configured to communicate with the in-memory business system 105 over a local area network. In some embodiments, the local network client application 113-3 can be specific to a corresponding business module 107. Accordingly, each client device 115 can execute multiple client applications 113 to access multiple corresponding business modules 107. For example, the local network client application 113-3 may be specifically implemented to communicate with the CRM 107-3 or the ERP 107-4. To address the complexity of providing enrichment services to multiple, and possibly independent client applications 113, embodiments of the present disclosure include one or more plug-ins 117 implemented for a particular client device 115, a particular client application 113, or a corresponding operating system specific to the client device 115 and/or client application 113 to provide access to the enrichment service 120.

The plug-ins 117 can be implemented as computer executable code or code segments that can be loaded from one or more corresponding configuration files when the client device 115 is activated or when a client application 113 is executed. In embodiments, the plug-ins 117 include communication functionality to provide communication between the client application 113 and the enrichment service 120 though the communication layer 121. In such embodiments, the communication layer 121 can include various command handlers 122. The command handlers can correspond to a particular plug-in 117 or a type of plug-in (e.g., a plug-in for a particular type of client device 115 or type of client application 113). For example, the local network client application 113-3 can communicate with the enrichment service 120 through the corresponding plug-in 117-3 and local network enrichment command handler 122-1. Similarly, the mobile client application 113-4 can access the enrichment service 120 through the corresponding pair of plug-in 117 and the mobile enrichment command handler 122-2. In some embodiments, access to the enrichment service 120 can be provided through a cloud portal for on-demand data enrichment 150. In such embodiments, the web/cloud client 113-5 can access the enrichment service 120 through the plug-in 117-5, the cloud portal for on-demand enrichment 150, and the cloud enrichment command handler 122-3.

In embodiments, the command handler 122 and plug-in 117 pairs include functionality for handling the communication between the client applications 113 and the enrichment service logic layer 125 over corresponding types of electronic communication protocols and media. In the specific example illustrated in FIG. 2A, the local network client 113-3 communicates with the local network enrichment command handler 122-1 over a local area wireless or wired network. Such configurations are typical of secured local area networks within a particular company. Similarly, the mobile client application 113-4 can communicate with the mobile enrichment command handler 122-2 over various types of licensed wireless communication networks (e.g. GSM, GPRS, LTE, WiMAX, etc.). Finally, the web/cloud client 113-5 can communicate with the cloud enrichment command handler 122-3 through a wide area network, such as the Internet and/or one or more cloud computing environments.

In some embodiments, the plug-ins 117 also include functionality for inserting controls into user interfaces provided by the client applications 113 with which users can interact to invoke functionality of the enrichment service 120. For example, plug-ins 117 can insert additional menu items, buttons, or other controls into a GUI rendered by the client applications 113 for generating enrichment data commands. Such controls can include mechanisms with which users can select specific reporting data shown by a client application 113 so that it can be included in an enrichment command. In one illustrative example, a user 103 may highlight a specific data element in a report table or a particular data point in a visual representation to indicate the data in the report the user would like to have enriched. Once the data is selected, user 103 may then click an enrich data button. In response, the plug-in 117 can generate a data enrichment command that includes the selected data, and send it to an enrichment data command handler 122 to invoke the functionalities of the enrichment service 120.

In addition to the selected data to be enriched, a plug-in 117 can also provide other contextual information in the data enrichment command. The plug-in 117 can determine the context of the data enrichment command, such as an identifier for the requesting user 103 (e.g., a username), a level of authorization for user 103, the client device identifier, identifier or serial number for the instance of the client application 113, a report definition identifier associated with the selected report data, and the like.

For example, the plug-in 117 can determine context information that includes a description of the client application 113 or the particular report or report definition from which the data enrichment command was initiated. Accordingly, the enrichment service logic layer 123 can access a context/preference data store 129 to determine what enrichment data may be useful for particular user 103 viewing information in that particular context. In one instance, a user 103 may be accessing CRM 107-3 using a mobile computing device 115-4 and a corresponding mobile client application 113-4. When that user selects a piece of reporting data (e.g., using a finger gestures to highlight a particular data point) and operates an enrich data command button, the corresponding plug-in 117-4 can recognize context data for the particular circumstances. Such context data can include identification of the mobile client application 113-4 used to access the corresponding CRM 107-3, a user identifier, the time and date, and some indication as to the nature of the report from which the report data was selected. Based on context data, the enrichment service logic layer 123 can retrieve an enrichment data definition associated with that particular set of context data from the context/preference data store 129. Accordingly, the enrichment data definition can be associated with a particular user 103, client application one and 13, business model 107, or any other context information included in the data enrichment command.

In some embodiments, the enrichment data definition stored in the context/preference data store 129 can be predetermined as customized or general settings. For example, a particular user 103 may select which enrichment data, and the corresponding sources from which it can be gathered, is to be provided in various contexts. In other embodiments, default or general enrichment data definitions can be set for various contexts. Accordingly, whenever any user 103 requests enrichment data in a particular context, the enrichment service logic layer 123 can generate the appropriate enrichment data requests to query the corresponding enrichment data sources 130 according to the enrichment data definitions. As used herein, the term “enrichment data definition” refers to a list or file of specifications that define a type of enrichment data, an enrichment data source, the query syntax for the enrichment data source, and/or the format in which the enrichment data should be presented in a user interface.

In one embodiment, enrichment data definitions can be adaptive and change dynamically according to patterns of use. For example, while a default enrichment data definition may be used to gather and present a particular set of enrichment data to a user in a particular context, enrichment service logic layer 125 can receive feedback information from client application 113 or the plug-in 117 about how one or more users 103 interact with the resulting enrichment data. If a particular type of enrichment data is determined to be unused or infrequently used in a particular context, enrichment service logic layer 123 can change one or more of the enrichment data definitions in the context/preference data store 129. On the other hand, if a particular type of enrichment data is determined to be frequently referenced in many contexts, enrichment service logic layer 123 can update other enrichment data definitions to include such enrichment data.

Once the enrichment service logic layer 123 has generated the necessary enrichment data requests, the data source connector layer 125 can route the request to the appropriate target enrichment data sources 130. In some embodiments, the enrichment data requests can be sent to web-based enrichment data source 130-2 (e.g., Google™, Equifax™, Dun & Bradstreet™, etc.) or a local data store 130-1. In other embodiments, the data source connector layer 125 can route the enrichment data requests to one or more of the business modules 107 in the in-memory business system 105. The enrichment data sources 130 or business model 107 can then return the requested enrichment data to the requesting client device 115 through the various component layers of enrichment service 120.

As previously discussed, the enrichment service logic layer 123 can store the enrichment data in the enriched data store 140. Storing the enriched data, in association with the relevant context and selected report data, can provide historization of the enrichment data and record of the use of the enrichment data. The historization can then be used to inform or update enrichment data definitions in the context/preference data store 129.

To further illustrate various aspects of the present disclosure, FIG. 2B illustrates a particular data flow for providing enrichment data to web/cloud client application 113-5 that accesses the enrichment service 120 through cloud portal for on-demand data enrichment 150 (e.g., a website or remote application executed on one or more processors in a server computer or cloud computing environment). In response to user input received through controls embedded in a GUI of the web/cloud client application 113-5 (e.g., a general-purpose web browser), the plug-in 117-5 can generate an enrichment data command at action (1) (reference 211). As described herein, the enrichment data command can include information corresponding to the selected data in a particular report displayed by the web/how client application 113-5, and/or the context in which the enrichment data was requested.

In the particular example shown in FIG. 2B, the plug-in 117-5 can send the enrichment data command to the cloud portal for on-demand data enrichment 150. In some embodiments, the cloud portal for on-demand data enrichment can include authorization functionality for granting access to the client device 115-5 and/or the user 103. The cloud portal for on-demand data enrichment 150 can then forward the enrichment data to the enrichment service 120 at action (2) (reference 213). Because the enrichment data command was routed through the cloud portal for on-demand enrichment 150, a cloud enrichment command handler 122-3 corresponding to the plug-in 117-5 can receive, translate, or otherwise process the incoming enrichment data command at action (3) (reference 215). For example, the cloud enrichment command handler 122-3 can format the enrichment data command into a formatted enrichment data request that the enrichment service logic layer 123 can interpret and use.

At action (4) (reference 217), the enrichment service logic layer 125 can query the context/preference data store 129 to determine one or more types of enrichment data that might be useful for the requesting user based on the highlighted reporting data and/or the context in which it was selected. In response to the query, the context/preference data store 129 can return an enrichment data definition at action (5) reference 219. As disclosed herein, the enrichment data definition can include specifications for the type of enrichment data, potential enrichment data sources for the particular type of enrichment data, the location of the potential enrichment data sources (e.g., network addresses on internal or external networks), as well as template queries for obtaining such enrichment data from the sources.

Based on the enrichment data definitions, enrichment service logic layer 125 can generate one or more enrichment data requests in action (6) (reference 221). The data source connector layer 127 can then translate and route the enrichment data requests to the appropriate enrichment data sources 130. In the particular example shown, the data source connector layer 127 can generate multiple translated enrichment data requests and route them to the appropriate enrichment data sources 130 (actions (7) and (9) at references 223 and 227). The translated enrichment data requests can include network addresses and query syntax or formatting specific to each one of the target enrichment data sources 130. As shown, the enrichment data sources 130 can include both local data sources 130-1 and web-based judgment data sources 130-2.

In response to the translated enrichment data request, the enrichment data sources can return the requested enrichment data (actions (8) and (10) at references 225 and 229). The data source connector layer 127 can then translate the responses from the enrichment data sources 130 into a format usable by the enrichment service logic layer 125 at action (11) (reference 231).

At action (12) (reference 233), the service logic layer 125 can generate processed enrichment data that can include the enrichment data and specifications for how the enrichment data should be displayed to the user. For example, the processed enrichment data can include specifications for a particular summary report or visual representation. The specifications can define the size, format, location, interactive elements (e.g., hyperlinks), and other elements to be included in the display of the enrichment data.

At action (13) (reference 235), the cloud enrichment command handler 122-3 can reformat the processed enrichment data and forward it to the cloud portal for on-demand data enrichment 150. In some embodiments, the cloud portal for on-demand data enrichment 150 can simply forward the formatted and processed enrichment data to the requesting client device 115-5, at action (14) (reference 237). However in other embodiments, the cloud portal for on-demand data enrichment 150 may further process the formatted enrichment data to include security or encryption elements to protect the formatted enrichment data while being transmitted to the target client device 115-5.

Finally, at action (15) (reference 239), the enrichment service logic layer 125 can record the enrichment data determined in response to the data enrichment command. In addition to the enrichment data, enrichment service logic layer 125 can also store information regarding the context, the time/date, and any other information related to the process of receiving the data enrichment command and retrieving the resulting enrichment data.

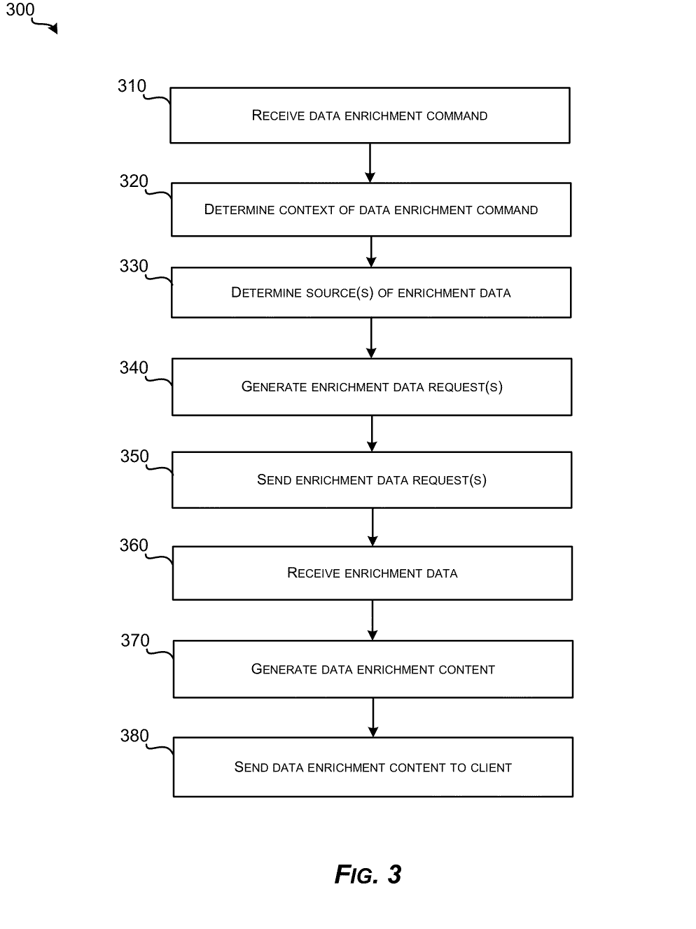

FIG. 3 is a flowchart of a method 300 for providing on-demand enrichment data, according to various embodiments the present disclosure. The method 300 includes descriptions of actions from the perspective of a computer system, such as a server computer or cluster of virtual processors in a cloud computing environment, executing the enrichment service 120. Method 300 can begin at block 310 in which the computer system can receive the data enrichment command from one or more client computing devices. The data enrichment command can include one or more pieces of data from a particular report or visual analytic being displayed to a user on the client computing device 115.

At block 320, the computer system can analyze the data enrichment command to determine the context in which the data enrichment command was issued. As described herein, the context can include information about the requesting user 103, the client device 115, the client application 113, the particular report or other point of origin from which the highlighted report data was selected, and the like. In action 330, the computer system can determine one or more sources of enrichment data based on the highlighted report data and/or the context from which the highlighted report it was selected. In some embodiments, determining the enrichment data sources can include referencing a local context/preference data store 129 that includes enrichment data definitions associated with specific contexts, users 103, client devices 115, and/or client applications 113. The enrichment data definitions can also include specifications, such as messaging formats and query templates, that the computer system can use in block 340 to generate one or more enrichment data requests.

In block 350, the computer system can send the enrichment data requests to the corresponding enrichment data sources. In response to the enrichment data requests, the computer system can receive the requested enrichment data, in block 360. In block 370, the computer system can generate data enrichment content based on the received enrichment data. In some embodiments, the data enrichment content can include the received enrichment data and instructions for displaying enrichment data in a particular context. For example, if the specific report data received in the data enrichment command includes numerical data selected from a graphical representation of a table of data, then the enrichment data content can include specifications for displaying the enrichment data in a graphical form. In block 380, the computer system can send the data enrichment content to the requesting client device 115. In some embodiments, the data enrichment content can be sent directly to the client device 115 through a local area network. However, in other embodiments, the data enrichment content can be routed through one or more external networks that in turn forward the data to the requesting client device 115.

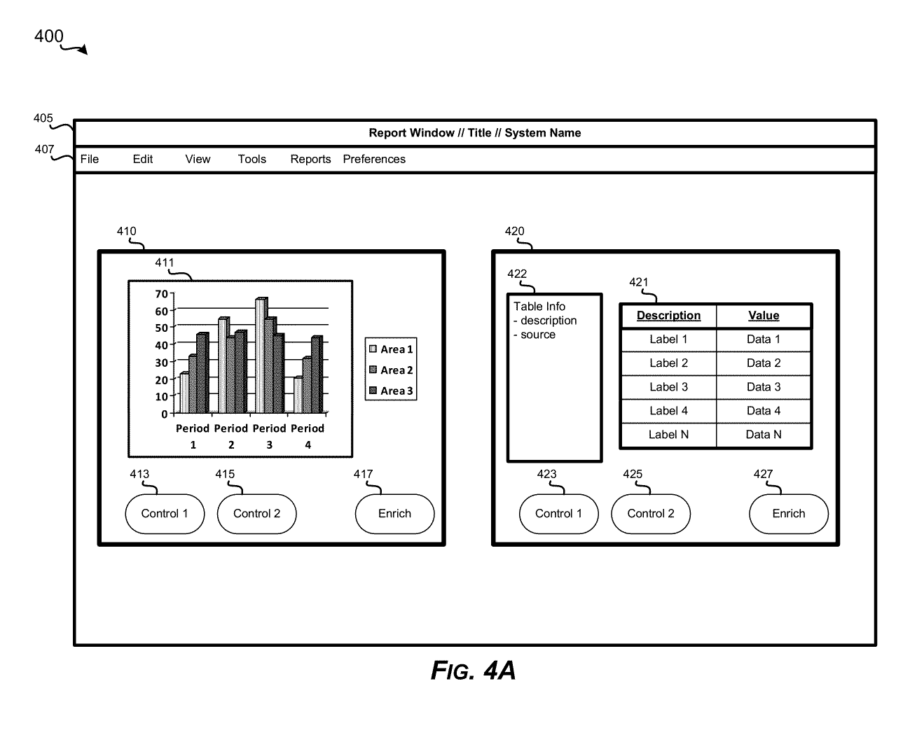

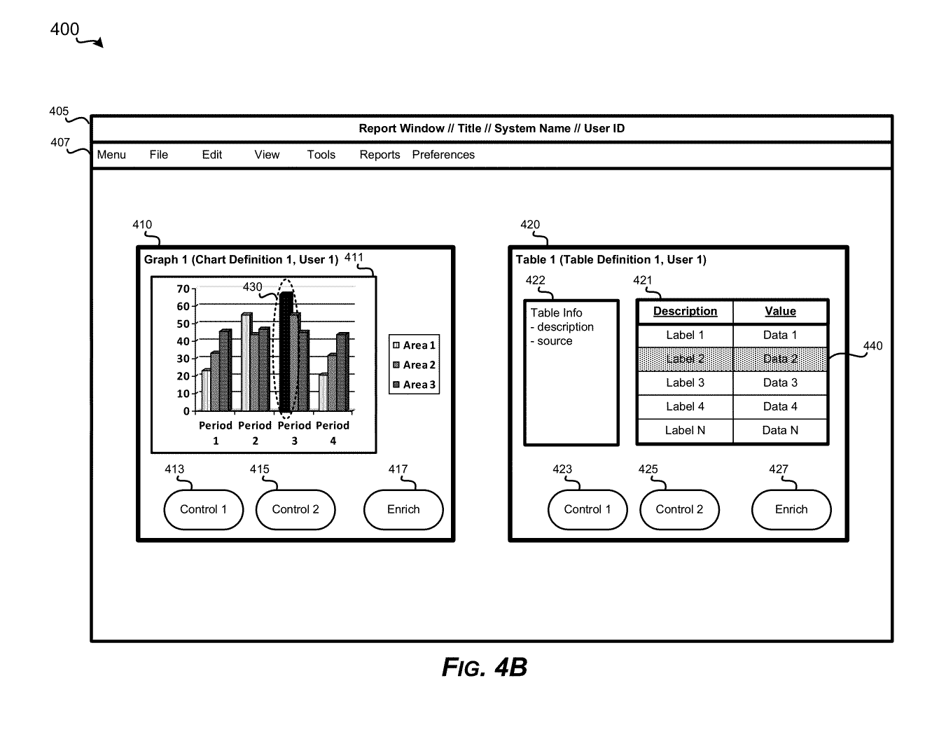

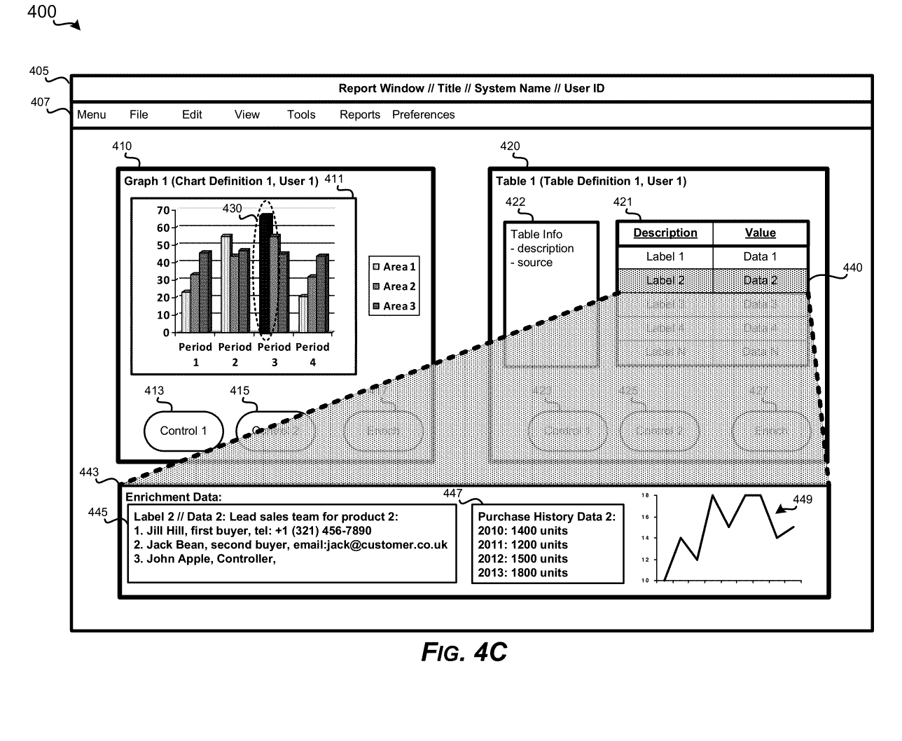

FIGS. 4A through 4C illustrate presentation of enrichment data in a reporting GUI 400 rendered on a client computing device 115, in accordance with embodiments of the present disclosure. The reporting GUI 400 can include a dashboard of one or more individual reports or visual representations.

As shown the GUI 400 can include a title region 405 that includes information about the GUI 400. For example, the title region 405 can include a report window identifier/name, the title/identifier of the report(s), and a system name, such as the name of the business module(s) 107 from which the report data displayed in the GUI 400 is retrieved. The information in the title region can also be included in metadata about the contents of the GUI 400 that the plug-in 117 can access to determine the context data. The GUI 400 may also include a menu region 407 that includes pull-down menus or other controls for controlling various aspects of the GUI 400 and the underlying data and requests.

As shown, the menu region 407 may include a preferences pull-down menu for a user to enter/edit context-specific data reporting and summary preferences. In other embodiments, the preferences can include options for selecting predetermined data reporting settings (i.e., election of predefined reports and graphical representations of those reports). For instance, the GUI 400 can include a custom or default visual representation 410 or tabular report 420 of data retrieved from one or more business modules 107. Visual representation 410 can include a graphic, such as bar graph 411, while the tabular report 420 can include a table 421 and information 422 about the data displayed in the table. In addition, the visual representation 410 and the tabular report 420 can include the controls 413, 415, 417, 423, 425, and 427. In embodiments the present disclosure, the controls 413, 415, 417, 423, 425, and 427 can be inserted into visual representation 410 and tabular report 420 by a corresponding plug-in 117 specifically designed to facilitate communication between the client application 113 and the data enrichment service 120. In particular, the visual representation 410 and the tabular report 420 can include buttons 417 and 427 that a user can use to activate the corresponding plug-in 117 to invoke functionality of the enrichment service 120, described herein.

As shown in FIG. 4B, a user can select different pieces of reporting data displayed in either the visual representation 410 or the tabular report 420. In the specific example shown, when a user clicks on or otherwise selects the bar graph element 430 or the row 440, the corresponding data can be highlighted or differentiated from the non-selected report data. When the report data is selected, the user can then click the corresponding enrich data control button 417 or 427. In reference to the highlighted row 440 in the tabular report 420, clicking on the enrich data button 427 invoke functionality of the plug-in 117 to determine the data in the selected row 440 and other information regarding the context in which the selected report data was chosen.

In some embodiments, when the plug-in 117 determines the context, it determines information about the tabular report 420, such as specifications that define the required analysis for the reporting table and layout of that table. The plug-in 117 can also determine an identifier and level of authorization associated with the requesting user. The plug-in 117 can the compile the context information and the selected reporting data into a data enrichment command and send it to the enrichment data service 120. In response, the client application 113 used to generate the tabular report 420 can receive enrichment data according to one or more enrichment data definitions determined to be associated with the particular context and selected reporting data. The client application 113 can then use the enrichment data received from the data enrichment service 120 to generate and render the enrichment data 443 depicted in FIG. 4C. Enrichment data 443 can include graphical representations of the enrichment data presented according to specifications in the enrichment data content or the enrichment data definition. In the particular example shown, enrichment data 443 includes listings of data 445, tables of data 447, and graphical charts 449. Specifically, the enrichment data 443 shown includes a listing 445 of relevant personnel for a particular customer, purchase a table 447 of the history for particular a product, and the line graph 449 of a particular metric of interest (e.g. stock price, forecasted production capability, and the like).

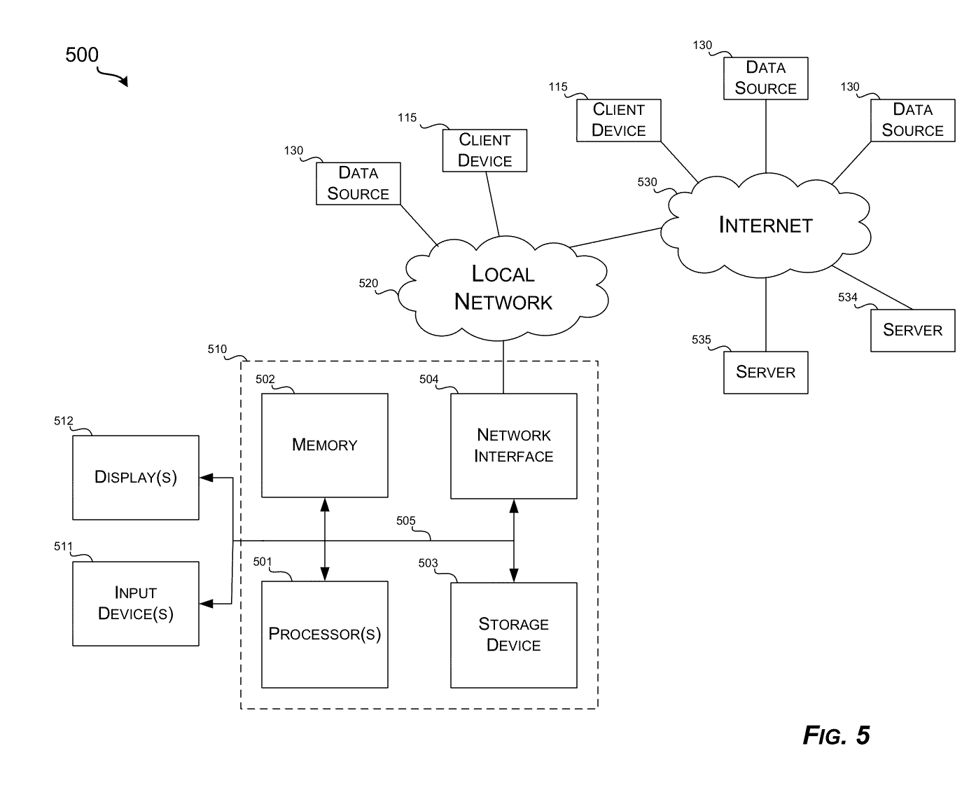

To illustrate the example systems of hardware, software, and networks that can implement embodiments of the present disclosure, we now turn to FIG. 5. FIG. 5 illustrates example computer system and networks 500 that may be used to implement embodiments of the present disclosure. Computer system 510 includes a bus 505 or other communication mechanism for communicating information, and a processor 501 coupled with bus 505 for processing information. Computer system 510 also includes a memory 502 coupled to bus 505 for storing information and instructions to be executed by processor 501, including instructions for performing the techniques described above. This memory may also be used for storing temporary variables or other intermediate information during execution of instructions to be executed by processor 501. Possible implementations of this memory may be, but are not limited to, random access memory (RAM), read only memory (ROM), or both. A storage device 503 is also provided for storing information and instructions. The information instructions can be in the form of computer readable code stored on the storage device, accessible and executable by processor to implement various techniques and methods of the present disclosure. Common forms of storage devices include non-transitory, non- volatile computer readable media, for example, a hard drive, a magnetic disk, an optical disk, a CD, a DVD, a flash memory, a USB memory card, or any other medium from which a computer can read.

Computer system 510 may be coupled via the same or different information bus, such as bus 505, to a display device 512, such as a touchscreen, a liquid crystal display (LCD), and LED display, and the like, for displaying information. An input device 511 such as a keyboard, touchscreen, and/or mouse is coupled to a bus for communicating information and command selections from the user to processor 501. The combination of these components allows the user to communicate with and enter user input into the system. In some embodiments, the display 512 and the input device 511 may be implemented in a single device, such as a touchscreen.

Computer system 510 also includes a network interface 504 coupled with bus 505. Network interface 504 may provide two-way data communication between computer system 510 and the local network 520. The network interface 504 may be a local area network (LAN) card to provide a data communication connection to a compatible LAN. The LAN card may include a wireless LAN (WLAN) card for communicating with a corresponding wireless network. In any such implementation, network interface 504 sends and receives electrical, electromagnetic, or optical signals that carry digital data streams representing various types of information.

Computer system 510 can send and receive information, including messages, commands, requests, or other interface actions, through the network interface 504 to an Intranet or the Internet 530. In the Internet example, software components or services may reside on multiple different computer systems 510 or servers 534 and 535 across the network. Software components described above may be implemented on one or more servers. A server 534 may transmit messages from one component, through Internet 530, local network 520, and network interface 504 to a component on computer system 510, for example. Software components of a composite application may be implemented on the same system as other components, or on a different machine than other software components. This process of sending and receiving information between software components may be applied to communication between computer system 510 and any of the servers 534 and 535 in either direction. It may also be applied to communication between any two servers 534 to 535.

The example computer system and networks 500 also illustrates the connection between the computer system 510 and enrichment data services 130 and client devices 115 over the local network 528 and/or Internet 530. In some embodiments, the in-memory business system 105 can be implemented over one or more of the networks in the cloud computing configuration using one or more of the computer system 510 and sever computers 534 and 535.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
generating, by a computing system, in response to a query received from a client computing device, reporting data comprising data from one or more records retrieved from one or more data sources;
sending the reporting data from the computing system to the client computing system;
receiving, by the computing system, a data enrichment command comprising a subset of the reporting data and a context in which the subset of the reporting data was determined, from the client computing device;
analyzing, by the computing system, the subset of the reporting data and the context to determine an enrichment data source;
determining, by the computer system, a query syntax associated with the enrichment data source;
generating, by the computer system, a request for enrichment data based on the subset of the reporting data, the context, and the query syntax;
sending the request for enrichment data from the computer system to the enrichment data source;
receiving, by the computer system, enrichment data from the enrichment data source; and
sending the enrichment data from the computer system to the client computing device.

2. The method of claim 1 wherein the one or more data sources comprise a business module executed in the computer system and comprising analytical or transactional functionality.

3. The method of claim 1 wherein analyzing the context comprises accessing an enrichment data definition associated with the context, and wherein the data definition comprises a designation of an enrichment data type and the enrichment data source.

4. The method of claim 3 further comprising updating the enrichment data definition in response to feedback information received from the client computing device.

5. The method of claim 1 wherein determining the query syntax comprises accessing an enrichment data definition, associated with the context, and comprising a query template associated with the enrichment data source, and wherein generating the request comprises using the query template.

6. The method of claim 1 wherein the enrichment data source comprises an auxiliary data source external to the computer system.

7. The method of claim 1 further comprising processing the enrichment data to generate processed enrichment data comprising specifications for displaying the enrichment data, and wherein sending the enrichment data to the client computing device comprises sending the processed enrichment data.

8. A non-transitory computer readable medium comprising instructions that, when executed by a computer processor, cause the computer processer to be configured for:
receiving, from a client computing device, a data enrichment command comprising reporting data comprising data from one or more records retrieved from one or more data sources, and a context in which the reporting data was selected;
analyzing the reporting data and the context to determine an enrichment data source;
determining a query syntax associated with the enrichment data source;
generating a request for enrichment data based on the reporting data, the context, and the query syntax;
sending the request for enrichment data to the enrichment data source;
receiving, in response to the request for enrichment data, enrichment data from the enrichment data source; and
sending the enrichment data to the client computing device.

9. The non-transitory computer readable medium of claim 8 wherein the one or more data sources comprise a business module comprising analytical or transactional functionality.

10. The non-transitory computer readable medium of claim 8 wherein analyzing the context comprises accessing an enrichment data definition associated with the context, and wherein the data definition comprises a designation of an enrichment data type and the enrichment data source.

11. The non-transitory computer readable medium of claim 8 wherein the instructions further cause the computer processor to be configured for updating the enrichment data definition in response to feedback information received from the client computing device.

12. The non-transitory computer readable medium of claim 8 wherein determining the query syntax comprises accessing an enrichment data definition, associated with the context, and comprising a query template associated with the enrichment data source, and wherein generating the request comprises using the query template.

13. The non-transitory computer readable medium of claim 8 wherein the enrichment data source comprises an external auxiliary data source.

14. The non-transitory computer readable medium of claim 8 wherein the instructions further cause the computer processor to be configured for processing the enrichment data to generate processed enrichment data comprising specifications for displaying the enrichment data, and wherein sending the enrichment data to the client computing device comprises sending the processed enrichment data.

15. A system comprising:
a processor; and
a memory coupled to the processor and comprising instructions that, when executed by the processor, cause the processor to be configured to:
receive, from a client computing device, a data enrichment command comprising reporting data comprising data from one or more records retrieved from one or more data sources, and a context in which the reporting data was determined;
analyze the reporting data and the context to determine an enrichment data source;
determine a query syntax associated with the enrichment data source;
generate a request for enrichment data based on the reporting data, the context, and the query syntax;
send the request for enrichment data to the enrichment data source;
receive enrichment data from the enrichment data source; and
send the enrichment data to the client computing device.

16. The system of claim 15 wherein the one or more data sources comprise a business module comprising analytical or transactional functionality.

17. The system of claim 15 wherein the instructions that cause the processor to analyze the context comprise instructions that cause the processor to access an enrichment data definition associated with the context, wherein the data definition comprises a designation of an enrichment data type and the enrichment data source.

18. The system of claim 15 wherein the instructions further cause the processor to be configured to update the enrichment data definition in response to feedback information received from the client computing device.

19. The system of claim 15 wherein the instructions that cause the processor to determine the query syntax comprise instructions that cause the processor to access an enrichment data definition, associated with the context, and comprising a query template associated with the enrichment data source, and wherein the instructions that cause the processor to generate the request comprise instructions that cause the processor to use the query template.

20. The system of claim 15 wherein the instructions further cause the processor to be configured to process the enrichment data to generate processed enrichment data comprising specifications for displaying the enrichment data and wherein the instructions that cause the processor to send the enrichment data to the client computing device comprise instructions that cause the processor to be configured to send the processed enrichment data.
